(19) United States
(12) Patent Application Publication
(10) Pub. No.: US 2025/0372729 A1
(43) Pub. Date: Dec. 4, 2025

(54) SOLID-STATE BATTERY

(71) Applicant: TOYOTA JIDOSHA KABUSHIKI KAISHA, Toyota-shi (JP)

(72) Inventors: Ryo ASAKURA, Sunto-gun (JP); Shinya Shiotani, Nagoya-shi (JP)

(73) Assignee: TOYOTA JIDOSHA KABUSHIKI KAISHA, Toyota-shi (JP)

(21) Appl. No.: 19/032,613

(22) Filed: Jan. 21, 2025

(30) Foreign Application Priority Data
Jun. 4, 2024 (JP) 2024-090789

(51) Int. Cl. H01M 10/42; H01M 4/02; H01M 10/0585

(52) U.S. Cl. CPC H01M 10/4235; H01M 10/0585; H01M 2004/027

(57) ABSTRACT

This disclosure provides a solid-state battery that has a negative electrode layer, a protection layer, a solid electrolyte layer, and a positive electrode layer in this order and uses a deposition-dissolution reaction of metal lithium. The negative electrode layer includes a first metal element that is able to alloy with lithium. The protection layer includes a second metal element that is able to alloy with lithium. The first and the second metal elements are different elements; and, as seen in a sectional view of the solid-state battery along a thickness direction, the protection layer has a first protruded portion that is protruded outward beyond an end face of the negative electrode layer in a direction orthogonal to the thickness direction, and the solid electrolyte layer has a second protruded portion that is protruded outward beyond an end face of the protection layer in the direction orthogonal to the thickness direction.

### CROSS-REFERENCE TO RELATED APPLICATION

This application claims priority to Japanese Patent Application No. 2024-090789 filed on Jun. 4, 2024, incorporated herein by reference in its entirety.

### BACKGROUND

### 1. Technical Field

This disclosure relates to a solid-state battery.

### 2. Description of Related Art

Regarding solid-state batteries, various technologies have been proposed (e.g., Japanese Unexamined Patent Application Publication No. 2022-186164 (JP 2022-186164 A), Japanese Unexamined Patent Application Publication No. 2023-150044 (JP 2023-150044 A), and Japanese Unexamined Patent Application Publication No. 2020-158835 (JP 2020-158835 A)). Examples of methods for increasing the energy density of a solid-state battery include adopting a lithium-based active material, such as metal lithium, and adopting an anode-free structure that is created without a negative electrode layer.

Meanwhile, as a method for improving the cycle characteristics and the rate characteristics of a solid-state battery, a method that forms a protection layer between a negative electrode layer and a solid electrolyte layer has been proposed.

For example, JP 2022-186164 A describes a lithium deposition-type secondary battery, in which a protection layer is provided on at least part of a principal surface of a solid electrolyte layer that faces a negative electrode current collector and at least part of side surfaces of the solid electrolyte layer, and the protection layer prevents contact between a negative electrode active material and the solid electrolyte layer and thereby prevents deterioration of the solid electrolyte layer.

As the protection layer disposed between the negative electrode layer and the solid electrolyte layer, a protection layer made of metal, such as Sn, is sometimes used.

### SUMMARY

In a solid-state battery that uses a deposition-dissolution reaction of metal lithium, short-circuiting of the solid-state battery sometimes occurs when, due to a restraining pressure or expansion and contraction during charging, the protection layer skirts the side surface of the solid electrolyte layer to the positive electrode layer side and comes into contact with the positive electrode layer. In other cases, short-circuiting occurs when the negative electrode layer expands during charging and extends to a region where the protection layer is not formed, and thus the solid electrolyte layer and the negative electrode layer come into contact with each other, causing Li dendrites to deposit and stretch into the solid electrolyte layer.

This disclosure has been made in view of the above problem, and a main object thereof is to provide a solid-state battery that can inhibit the occurrence of internal short-circuiting.

[1] A solid-state battery that has a negative electrode layer, a protection layer, a solid electrolyte layer, and a positive electrode layer in this order and uses a deposition-dissolution reaction of metal lithium, wherein:
the negative electrode layer includes a first metal element M1 that is able to alloy with lithium;
the protection layer includes a second metal element M2 that is able to alloy with lithium;
the first metal element M1 and the second metal element M2 are different elements; and
as seen in a sectional view of the solid-state battery along a thickness direction,
   the protection layer has a first protruded portion that is protruded outward beyond an end face of the negative electrode layer in a direction orthogonal to the thickness direction, and
the solid electrolyte layer has a second protruded portion that is protruded outward beyond an end face of the protection layer in the direction orthogonal to the thickness direction.

[2] The solid-state battery according to [1], wherein:
the solid-state battery has a negative electrode current collector on the opposite side of the negative electrode layer from the protection layer;
as seen in a sectional view along the thickness direction, the negative electrode current collector has an extended portion that is extended outward beyond the end face of the negative electrode layer in the direction orthogonal to the thickness direction; and
the extended portion has a bend in a region that overlaps the first protruded portion of the protection layer in the thickness direction.

[3] The solid-state battery according to [2], wherein the extended portion of the negative electrode current collector and the first protruded portion of the protection layer are separated from each other.

[4] The solid-state battery according to [2] or [3], wherein, as seen in a sectional view along the thickness direction, when the width of the first protruded portion of the protection layer on a side where the extended portion is present is α, the thickness of the negative electrode layer is β, and the angle of the bend of the extended portion on the acute angle side is θ, αtanθ<β is met.

[5] The solid-state battery according to any one of [2] to [4], wherein, as seen in a sectional view along the thickness direction, the thickness of the first protruded portion of the protection layer on a side where the extended portion is present is smaller than the thickness of a region where the first protruded portion is not provided.

This disclosure has the advantage of being able to provide a solid-state battery that can inhibit the occurrence of internal short-circuiting.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic sectional view showing one example of a solid-state battery in this disclosure;

FIG. 1B is a schematic sectional view showing one example of the solid-state battery in this disclosure;

FIG. 2A is a schematic sectional view showing one example of the solid-state battery in this disclosure;

FIG. 2B is a schematic sectional view showing one example of the solid-state battery in this disclosure;

FIG. 3 is a schematic sectional view showing one example of the solid-state battery in this disclosure;

FIG. 4 is a schematic sectional view showing one example of the solid-state battery in this disclosure;

FIG. 5 is a schematic sectional view showing one example of the solid-state battery in this disclosure;

FIG. 6A is a schematic sectional view of a solid-state battery obtained in Comparative Example 1; and

FIG. 6B is a schematic sectional view of a solid-state battery obtained in Comparative Example 2.

### DETAILED DESCRIPTION OF EMBODIMENTS

A solid-state battery in this disclosure will be described in detail below.

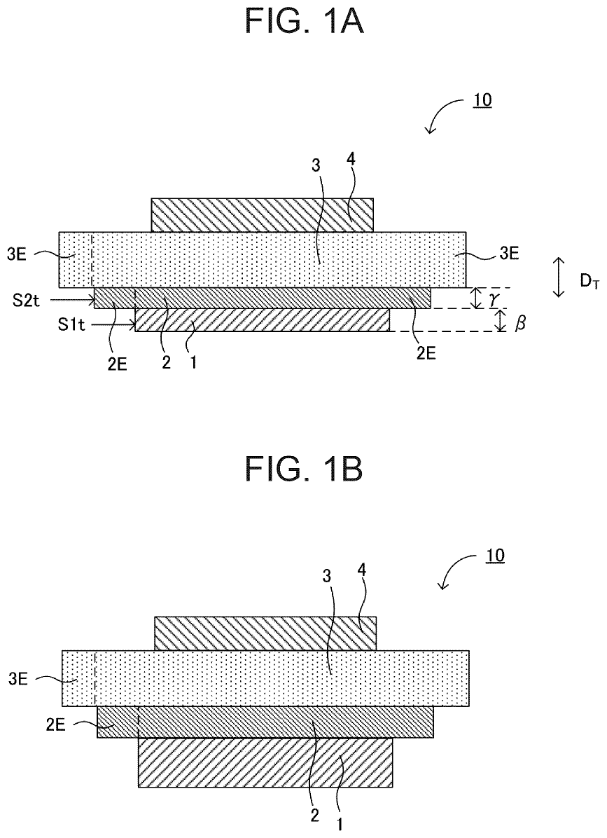

FIG. 1A and FIG. 1B are schematic sectional views showing one example of the solid-state battery in this disclosure. Specifically, FIG. 1A is a schematic sectional view illustrating the battery before initial charging, and FIG. 1B is a schematic sectional view illustrating the battery after the initial charging.

As shown in FIG. 1A and FIG. 1B, a solid-state battery 10 has a negative electrode layer 1, a protection layer 2, a solid electrolyte layer 3, and a positive electrode layer 4 in this order in a thickness direction Dr. The solid-state battery 10 is a solid-state battery that uses a deposition-dissolution reaction of metal lithium. As shown in FIG. 1A, in the solid-state battery 10 before initial charging, the negative electrode layer 1 includes a first metal element M1 that can alloy with lithium. The protection layer includes a second metal element M2 that can alloy with lithium. Here, the first metal element M1 and the second metal element M2 are different elements. When the solid-state battery 10 shown in FIG. 1A is charged, formation of an Li-M1 alloy progresses between lithium and the first metal element M1 in the negative electrode layer 1. That is, in the solid-state battery 10 after the charging shown in FIG. 1B, the negative electrode layer 1 contains an Li-M1 alloy. The negative electrode layer 1 after the charging has a metal Li phase. On the other hand, during discharging, Li dissolves from the Li-M1 alloy or the metal Li phase.

As seen in a sectional view of the solid-state battery 10 along the thickness direction DT, the protection layer 2 has a first protruded portion 2E that is protruded outward beyond an end face Slt of the negative electrode layer 1 in a direction orthogonal to the thickness direction DT, and the solid electrolyte layer 3 has a second protruded portion 3E that is protruded outward beyond an end face S2t of the protection layer 2 in the direction orthogonal to the thickness direction. The first protruded portion 2E and the second protruded portion 3E are each protruded parallel to the direction orthogonal to the thickness direction DT.

It is preferable that, as seen in a plan view of the solid-state battery, an entire outer edge of the solid electrolyte layer 3 be disposed outward of an entire outer edge of the protection layer 2. Similarly, it is preferable that the entire outer edge of the protection layer 2 be disposed outward of an entire outer edge of the negative electrode layer 1.

According to this disclosure, since the solid electrolyte layer has the second protruded portion, the protection layer can be inhibited from skirting a side surface of the solid electrolyte layer to the positive electrode layer side due to a restraining pressure and expansion and contraction during charging and discharging, and thus short-circuiting of the solid-state battery can be inhibited. Moreover, since the protection layer has the first protruded portion, even when the negative electrode layer expands during charging, contact between the negative electrode layer and the solid electrolyte layer in a region where the protection layer is not disposed can be inhibited. Accordingly, deposition and stretching of Li dendrites into the solid electrolyte layer due to contact between the negative electrode layer and the solid electrolyte layer can be inhibited, and thus short-circuiting of the solid-state battery can be inhibited. In addition, since the protection layer is provided between the negative electrode layer and the solid electrolyte layer, an interface between the negative electrode layer and the solid electrolyte layer can be reliably covered with the protection layer, which can prevent separation at the interface and improve the cycle characteristics and the rate characteristics.

### 1. Negative Electrode Layer

The negative electrode layer in this disclosure includes the first metal element M1 that can alloy with lithium. Examples of the first metal element M1 include Mg, Ag, In, Sn, Si, Ga, Au, and Pt. The negative electrode layer may contain only one type of the first metal element M1 or may contain two or more types thereof. The negative electrode layer may include an alloy of the first metal element M1 and Li. The negative electrode layer may include a metal Li phase.

Normally, Li is taken into the negative electrode layer during charging to form an Li-M1 alloy. During charging, a metal Li phase is formed in the negative electrode layer. On the other hand, the negative electrode layer before initial charging and when fully discharged may not contain Li or may contain Li.

As seen in a plan view of the solid-state battery, the area of the negative electrode layer is smaller than the area of the solid electrolyte layer and moreover smaller than the area of the protection layer. The ratio of the area (A1) of the negative electrode layer to the area (A3) of the solid electrolyte layer (A1/A3) may be, for example, 0.9 or lower or may be 0.8 or lower. On the other hand, this ratio (A1/A3) may be, for example, 0.5 or higher or may be 0.6 or higher. The ratio of the area (A1) of the negative electrode layer to the area (A2) of the protection layer (A1/A2) is, for example, lower than 1.0 and may be 0.9 or lower. On the other hand, this ratio (A1/A2) may be, for example, 0.6 or higher or may be 0.7 or higher.

As seen in a plan view of the solid-state battery, the area of the negative electrode layer and the area of the positive electrode layer may be the same or may be different. From the viewpoint of inhibiting deposition of Li dendrites, it is preferable that the area of the negative electrode layer be larger than the area of the positive electrode layer. The ratio of the area (A1) of the negative electrode layer 1 to the area (A4) of the positive electrode layer (A1/A4) is, for example, higher than 1.0, and may be 1.1 or higher or may be 1.2 or higher. On the other hand, this ratio (A1/A4) is, for example, 1.5 or lower, and may be 1.4 or lower or may be 1.3 or lower.

A thickness β of the negative electrode layer may be 0.1 μm or larger or may be 100 μm or smaller.

In this Description, the area of the negative electrode layer and the thickness of the negative electrode layer refer to the area and the thickness of the negative electrode layer in a fully discharged state.

The negative electrode layer may be a metal foil including the first metal element M1 or may be a vapor-deposited layer. Using a metal foil facilitates manufacturing of the solid-state battery. Like a metal foil and a vapor-deposited layer, the negative electrode layer in this disclosure may be a layer that does not contain a conductive material (e.g., a carbon material). Similarly, the negative electrode layer in this disclosure may be a layer that does not contain a binder (e.g., a polymer material).

### 2. Protection Layer

The protection layer includes the second metal element M2 that can alloy with lithium. The second metal element M2 is a metal element different from the first metal element M1. Examples of the second metal element M2 include Sn, In, Mg, Ag, Si, Ga, Zn, Sb, Bi, and Al. The protection layer may contain only one type of the second metal element or may contain two or more types thereof. In particular, it is preferable that the second metal element M2 includes at least one of an In element and an Sn element. The protection layer may include an alloy of the second metal element and Li.

The protection layer has the first protruded portion that is protruded outward beyond the end face of the negative electrode layer in the direction orthogonal to the thickness direction. That is, as seen in a plan view, the area of the protection layer is larger than the area of the negative electrode layer and smaller than the area of the solid electrolyte layer. The ratio of the area (A2) of the protection layer to the area (A3) of the solid electrolyte layer (A2/A3) is, for example, lower than 1.0 and may be 0.9 or lower. On the other hand, this ratio (A2/A3) may be, for example, 0.6 or higher or may be 0.7 or higher.

The shape of the protection layer as seen in a plan view may be any shape such that the area of the protection layer is smaller than the area of the solid electrolyte layer.

A thickness γ of the protection layer may be 0.1 μm or larger and may be 1 um or smaller. The thickness y of the protection layer refers to the thickness of the protection layer in a region where the first protruded portion 2E is not provided.

While the formation method of the protection layer is not particularly limited, one example is a method of forming it by a vapor deposition method, an ion plating method, a sputtering method, a chemical vapor deposition (CVD) method, etc. on one surface of the solid electrolyte layer as a film formation surface. From the viewpoint of being able to uniformly form the protection layer, the sputtering method is preferable.

### 3. Solid Electrolyte Layer

The solid electrolyte layer in this disclosure is a layer that contains at least a solid electrolyte. The solid electrolyte layer may contain a binder as necessary. The solid electrolyte layer may be in direct contact with the protection layer.

The solid electrolyte layer has the second protruded portion that is protruded outward beyond the end face of the protection layer in the direction orthogonal to the thickness direction. That is, as seen in a plan view, the area of the solid electrolyte layer is larger than the area of the negative electrode layer and larger than the area of the protection layer.

Examples of solid electrolytes include inorganic solid electrolytes, such as a halide solid electrolyte, a sulfide solid electrolyte, an oxide solid electrolyte, and a nitride solid electrolyte, and organic solid electrolytes, such as a polymer electrolyte and a gel electrolyte. Among these, the sulfide solid electrolyte is particularly preferable. This is because adhesion to a negative electrode tends to be favorable even when discharging has progressed.

It is preferable that the sulfide solid electrolyte contain, for example, an Li element, an X element (X is at least one type among P, As, Sb, Si, Ge, Sn, B, Al, Ga, and In), and an S element. The sulfide solid electrolyte may further contain at least either an O element or a halogen element. One example of the shape of the solid electrolyte is a particulate shape.

Examples of the sulfide solid electrolyte include Li₂S—P₂S₅, Li₂S—P₂S₅—GeS₂, Li₂S—P₂S₅—SnS₂, Li₂S—P₂S₂—SiS₂, Li₂S—P₂S₅—LiI, Li₂S—P₂S₅—LiI—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₂—LiI, Li₂S—B₂S₃, Li₂S—P₂S₅-ZₘSₙ (where m and n are positive numbers; Z is one of Ge, Zn, Ga), Li₂S—GeS₂, Li₂S—SiS₂—Li₃PO₄, and Li₂S—SiS₂—LiₓMO_{y} (where x and y are positive numbers; M is one of P, Si, Ge, B, Al, Ga, and In). The expression “Li₂S—P₂S₅” means a material formed using a raw material composition including Li₂S and P₂S₅; the same applies to the other expressions.

The solid electrolyte may be glass or may be glass ceramic or may be a crystalline material. Glass can be obtained by performing amorphous processing on a raw material composition (e.g., a mixture of Li₂S and P₂S₅). One example of the amorphous processing is mechanical milling. The mechanical milling may be dry mechanical milling or may be wet mechanical milling, and the latter is preferable. This is because the raw material composition can be prevented from sticking to a wall surface of a container etc. Glass ceramic can be obtained by performing heat treatment on glass. A crystalline material can be obtained, for example, by performing solid-phase reaction processing on the raw material composition. The solid electrolyte included in the solid electrolyte layer may be one type or may be two or more types. For example, both an inorganic solid electrolyte and an organic solid electrolyte may be contained.

It is preferable that the shape of the solid electrolyte be a particulate shape. The average particle diameter (D₅₀) of the solid electrolyte is, for example, 0.01 μm or larger. On the other hand, the average particle diameter (D₅₀) of the solid electrolyte is, for example, 10 μm or smaller and may be 5 μm or smaller. The Li ion conductivity of the solid electrolyte at 25° C. is, for example, 1·10⁻⁴ S/cm or higher, and is preferably 1·10⁻³ S/cm or higher.

The content of the solid electrolyte in the solid electrolyte layer is, for example, 70 weight % or higher and may be 90 weight % or higher. The solid electrolyte layer may contain a binder as necessary. Examples of binders include fluorine-based resins, such as polyvinylidene fluoride (PVDF) and polytetrafluoroethylene (PTFE), and rubber-based resins, such as acrylate-butadiene rubber (ABR) and styrene-butadiene rubber (SBR). The thickness of the solid electrolyte layer is, for example, 0.1 μm or larger. On the other hand, the thickness of the solid electrolyte layer is, for example, 300 μm or smaller and may be 100 μm or smaller.

### 4. Positive Electrode Layer

The positive electrode layer in this disclosure includes at least a positive electrode active material layer. The positive electrode layer may contain at least one of a solid electrolyte, a conductive material, and a binder.

While not particularly limited, the positive electrode active material is preferably a positive electrode active material that can store and release lithium ions. Examples include an oxide active material and a sulfur-based active material. Examples of oxide active materials include rock salt laminar-type active materials, such as LiCoO₂, LiMnO₂, LiNiO₂, LiVO₂, LiNi_{1/3}Co_{1/3}Mn_{1/3}O₂, and LiNi_{0.8}Co_{0.1}Al_{0.1}O₂; spinel-type active materials, such as LiMn₂O₄, Li₄Ti₅O₁₂, and Li (Ni_{0.5}Mn_{1.5})O₄; and olivine-type active materials, such as LiFePO₄, LiMnPO₄, LiNiPO₄, and LiCoPO₄. As the oxide active material, an LiMn spinel active material represented by Li₁₊ₓMn_{2-x-y}M_{y}O₄ (M is at least one type among Al, Mg, Co, Fe, Ni, and Zn; 0<x+y<2), lithium titanate, etc. may be used.

A coating layer containing an Li ion conducting oxide may be formed on a surface of the oxide active material. This is because a reaction between the oxide active material and the solid electrolyte can be inhibited. Examples of Li ion conducting oxides include LiNbO₃, Li₄Ti₅O₁₂, and Li₃PO₄. The thickness of the coating layer is, for example, 0.1 nm or larger and may be 1 nm or larger. On the other hand, the thickness of the coating layer is, for example, 100 nm or smaller and may be 20 nm or smaller. The coverage ratio of the coating layer on the surface of the oxide active material is, for example, 70% or higher and may be 90% or higher.

The sulfur-based active material is an active material containing at least an S element. The sulfur-based active material may or may not contain an Li element. Examples of sulfur-based active materials include elemental sulfur, lithium sulfide (Li₂S), and lithium polysulfide (Li₂Sx, 2≤x≤8).

The ratio of the positive electrode active material in the positive electrode active material layer is, for example, 20 weight % or higher, and may be 30 weight % or higher or may be 40 weight % or higher. On the other hand, the ratio of the positive electrode active material is, for example, 80 weight % or lower, and may be 70 weight % or lower or may be 60 weight % or lower.

One example of conductive materials is a carbon material. Examples of carbon materials include acetylene black, ketjenblack, VGCF, and graphite. The same contents that have been described in “3. Solid Electrolyte Layer” apply to the solid electrolyte and the binder. The thickness of the positive electrode active material layer is, for example, 0.1 μm or larger and 1000 μm or smaller.

The positive electrode layer can be formed by a conventionally commonly known method. The positive electrode layer can be obtained by, for example, feeding a positive electrode active material and other ingredients as necessary into a solvent and stirring to produce positive electrode slurry, applying this positive electrode slurry to one surface of a support body, such as a positive electrode current collector, and then drying the positive electrode slurry. As the support body, one having self-supportability can be selected as appropriate, without being particularly limited; for example, a metal foil made of Cu, Al, etc. can be used.

### 5. Negative Electrode Current Collector

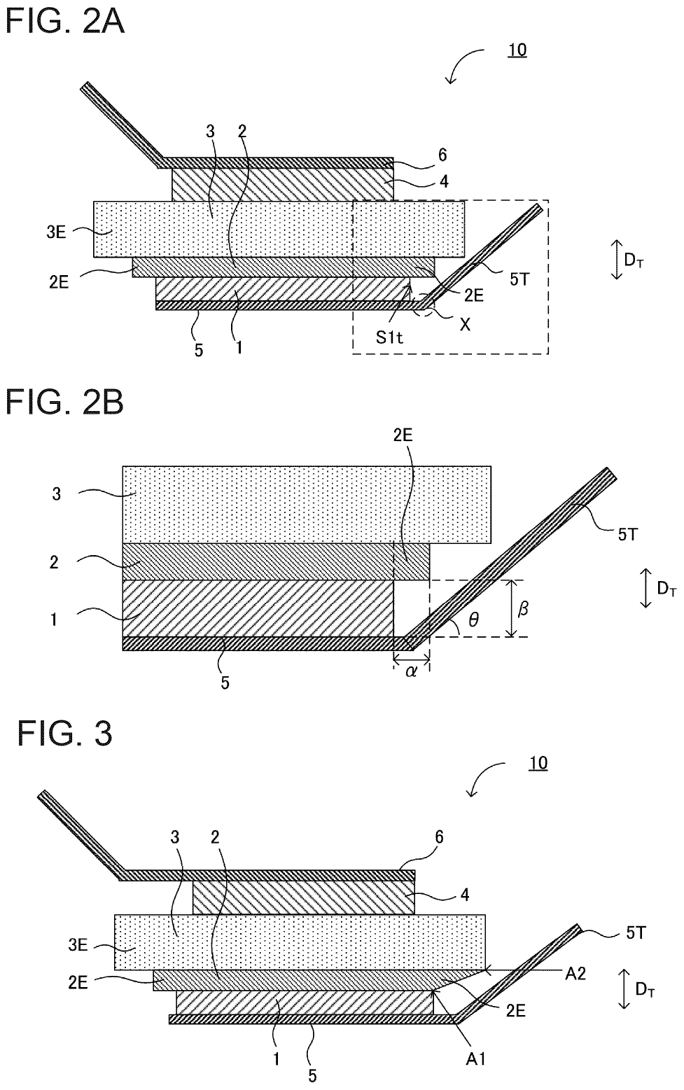

As shown in FIG. 2A, the solid-state battery 10 typically has a negative electrode current collector 5 on the opposite side of the negative electrode layer 1 from the protection layer 2. Examples of the material of the negative electrode current collector include SUS (stainless steel), copper, nickel, and carbon. Examples of the shape of the negative electrode current collector include a foil shape, a mesh shape, and a porous shape. The thickness of the negative electrode current collector is, for example, 0.1 μm or larger and may be 1 μm or larger. Too small a thickness of the negative electrode current collector may translate into a low current collection function. On the other hand, the thickness of the negative electrode current collector is, for example, 1 mm or smaller and may be 100 μm or smaller. Too large a thickness of the negative electrode current collector may translate into low energy density of the solid-state battery.

While the shape of the negative electrode current collector as seen in a plan view is not particularly limited, examples include a circular shape, an elliptic shape, a rectangular shape, and an arbitrary polygonal shape.

As shown in FIG. 2A, as seen in a sectional view along the thickness direction, the negative electrode current collector 5 may have an extended portion 5T that is extended outward beyond the end face Slt of the negative electrode layer 1 in the direction orthogonal to the thickness direction. When the solid-state battery includes a plurality of power generation units, the extended portions of the negative electrode current collectors of the respective power generation units are bundled together and connected to a negative electrode terminal. In this case, the extended portions of the negative electrode current collectors are bent. In this disclosure, as shown in FIG. 2A, it is preferable that the extended portion 5T of the negative electrode current collector 5 has a bend X in a region that overlaps the first protruded portion 2E of the protection layer 2 in the thickness direction. This is because the negative electrode current collectors can be compactly bundled together.

Further, as shown in FIG. 2A, it is preferable that the extended portion 5T of the negative electrode current collector 5 and the first protruded portion 2E of the protection layer 2 be separated from each other. This is because deposition of Li dendrites due to contact between the negative electrode current collector and the protection layer and the resulting internal short-circuiting can be inhibited.

As shown in FIG. 2B, as seen in a sectional view along the thickness direction D_{T}, when the width of the first protruded portion 2E of the protection layer 2 on the side where the extended portion 5T is present is α, the thickness of the negative electrode layer 1 is β, and the angle, on the acute angle side, of the bend X of the extended portion 5T of the negative electrode current collector 5 is θ, it is preferable that ═tanθ<β be met. This is because contact between the negative electrode current collector and the protection layer can be inhibited.

As shown in FIG. 3, as seen in a sectional view along the thickness direction DT, the first protruded portion 2E of the protection layer 2 on the side where the extended portion 5T is present may have an end A1 on the side of the negative electrode layer 1 disposed inward of an end A2 on the side of the solid electrolyte layer 3. This is because contact between the negative electrode current collector and the protection layer can be inhibited, and thereby deposition of Li dendrites and the resulting internal short-circuiting can be inhibited.

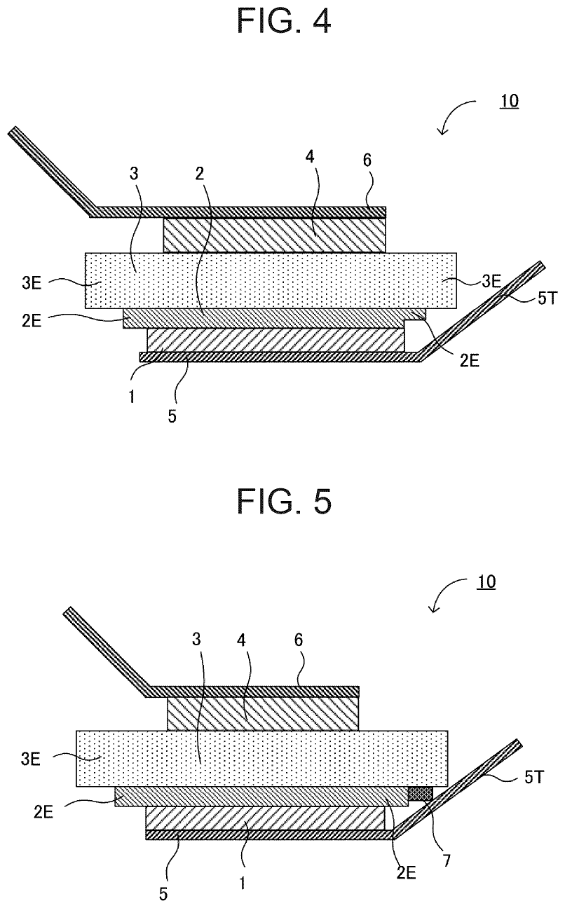

As shown in FIG. 4, the thickness of the first protruded portion 2E of the protection layer 2 on the side where the extended portion 5T is present may be smaller than the thickness of the protection layer 2 in a region where the first protruded portion 2E is not provided. This is because contact between the negative electrode current collector and the protection layer can be inhibited.

As shown in FIG. 5, the solid-state battery 10 may have an insulation member 7 disposed at an end of the first protruded portion 2E of the protection layer 2 on the side where the extended portion 5T is present. This is because contact between the negative electrode current collector and the protection layer can be inhibited. One example of the material of the insulation member is a resin. The resin may be a thermoplastic resin or may be a cured resin (e.g., a cured material, such as a thermosetting resin or an ultraviolet-curing resin). The insulation member may function as a buffer member that mitigates impact of contact with the extended portion.

### 6. Positive Electrode Current Collector

As shown in FIG. 2A, the solid-state battery 10 may have a positive electrode current collector 6 on the opposite side of the positive electrode layer 4 from the solid electrolyte layer 3. Examples of the material of the positive electrode current collector include copper, SUS, aluminum, nickel, iron, titanium, and carbon. Examples of the shape of the positive electrode current collector include a foil shape, a mesh shape, and a porous shape.

### 7. Other Components

The solid-state battery in this disclosure may further have a restraining jig that applies a restraining pressure to the positive electrode, the solid electrolyte layer, and the negative electrode along the thickness direction. As the restraining jig, a commonly known jig can be used. The restraining pressure is, for example, 0.1 MPa or higher and may be 1 MPa or higher. On the other hand, the restraining pressure is, for example, 50 MPa or lower, and may be 20 MPa or lower or may be 15 MPa or lower or may be 10 MPa or lower. The lower the restraining pressure is, the smaller the size of the restraining jig can be made. On the other hand, the lower the restraining pressure is, the more likely short-circuiting is to occur, but providing the protection layer in this disclosure can inhibit the occurrence of short-circuiting.

### 8. Solid-State Battery

In this disclosure, a solid-state battery means a battery including a solid electrolyte. The solid-state battery may be a semi-solid-state battery that is a solid-state battery including a solid electrolyte and a liquid material, or may be an all-solid-state battery that is a solid-state battery not including a liquid material.

When a set of a positive electrode, a solid electrolyte layer, and a negative electrode is a power generation unit, the solid-state battery may have only one power generation unit or two or more power generation units. When the solid-state battery has two or more power generation units, these power generation units may be connected in series or may be connected in parallel.

The solid-state battery in this disclosure is typically a lithium-ion battery. The solid-state battery in this disclosure may be a primary battery or may be a secondary battery, and particularly being a secondary battery is preferable. This is because it can be repeatedly charged and discharged and is useful as, for example, an on-board battery.

While the purpose of the battery is not particularly limited, examples include a power source of a vehicle, such as a hybrid electric vehicle (HEV), a plug-in hybrid electric vehicle (PHEV), a battery electric vehicle (BEV), a gasoline vehicle, and a diesel vehicle. In particular, it is preferable that the battery be used as a driving power source of a hybrid electric vehicle (HEV), a plug-in hybrid electric vehicle (PHEV), or a battery electric vehicle (BEV). In addition, the battery may be used as a power source of a mobile body other than a vehicle (e.g., a train, a ship, or an airplane), or may be used as a power source of an electrical product, such as an information processing device.

This disclosure is not limited to the above-described embodiment. The above-described embodiment is an illustration, and any embodiments that have substantially the same configuration as the technical idea described in the claims of this disclosure and produce similar workings and advantages are included in the technical scope of this disclosure.

### Example 1

### Production of Positive Electrode

As the positive electrode active material, NCA was used. As the solid electrolyte, a sulfide solid electrolyte was used. Using butyl butyrate as the solvent, the NCA, the solid electrolyte, a binder, and a conductive material were blended to a mass composition ratio of NCA: solid electrolyte: binder: conductive material=84.7:13.4:0.6:1.27 to produce positive electrode slurry. Next, the obtained positive electrode slurry was applied to an aluminum foil, serving as a positive electrode current collector, at an application gap of 225 μm. Then, the obtained coating film was subjected to temporary drying at 60° C. for a predetermined time, followed by main drying at 165° C. for one hour, to obtain a positive electrode in which a positive electrode layer with an amount per unit area of 18.7 mg/cm² and a design capacity of 3.0 mAh/cm² was formed on the positive electrode current collector.

### Production of Solid Electrolyte Layer

As the solid electrolyte, particles of a sulfide solid electrolyte with an average particle diameter (D₅₀) of 2.0 μm were used. Using butyl butyrate as the solvent, the sulfide solid electrolyte and a binder were blended to a mass composition ratio of sulfide solid electrolyte: binder=92.6:7.4 to obtain solid electrolyte slurry. Next, the solid electrolyte slurry was applied to a release film at an application gap of 325 μm. Then, the obtained coating film was subjected to temporary drying at room temperature for about three hours, followed by main drying at 165° C. for one hour. From the dried coated foil, two sheets of the coated foil with a diameter of 14.5 mm were stamped, and these two coated foils were laid on top of each other, with the coated surfaces facing each other, and subjected to pressing under 7 t. After the pressing, the release film was removed to obtain an independent solid electrolyte layer.

### Production of Protection Layer

On the independent solid electrolyte layer, a film of Sn was formed to a thickness of 0.1 μm as the protection layer by sputtering. During the sputtering, an appropriately sized mask was applied to the solid electrolyte layer such that the diameter of the protection layer became smaller than the diameter (14.5 mm) of the solid electrolyte layer.

### Production of Negative Electrode

As the negative electrode active material, an Mg foil with a thickness of 1.0 um was used. As the negative electrode current collector, an Ni foil was used. From the Mg foil and the Ni foil, pieces with a diameter of 13 mm were respectively stamped such that the diameters thereof became smaller than the diameter of the protection layer, and a negative electrode layer of the Mg foil was formed on the Ni foil. Thus, a negative electrode in which the negative electrode layer was formed on the negative electrode current collector was obtained.

### Production of Solid-State Battery

From the produced positive electrode, a piece with a diameter of 11.28 mm was stamped, and the produced independent solid electrolyte layer with a diameter of 14.5 mm was disposed between the positive electrode and the negative electrode to obtain a laminated body. Using Al for a positive electrode tab and Ni for a negative electrode tab, the laminated body was vacuum-sealed in an exterior body that was formed by a laminate film and provided with a positive electrode terminal and a negative electrode terminal, and thus a cell was obtained. The sealed cell was isostatically pressed under 392 MPa using cold isostatic pressing (CIP) to produce a laminated cell that was a solid-state battery.

The areas of laminated surfaces of the respective layers in the obtained solid-state battery were: solid electrolyte layer (diameter: 14.5 mm)>protection layer>negative electrode layer (diameter: 13 mm) >positive electrode layer (diameter: 11.28 mm), and the protection layer had the first protruded portion and the solid electrolyte layer had the second protruded portion. In the obtained solid-state battery, since the solid electrolyte layer had the second protruded portion, the protection layer was inhibited from skirting to the positive electrode layer during restraining and during charging and discharging, and thus short-circuiting was prevented. Moreover, since the protection layer had the first protruded portion, even when the negative electrode layer expanded during charging, contact between the negative electrode layer and the solid electrolyte layer in a region where the protection layer was not disposed was inhibited, and thus deposition and stretching of Li dendrites were inhibited.

### Comparative Example 1

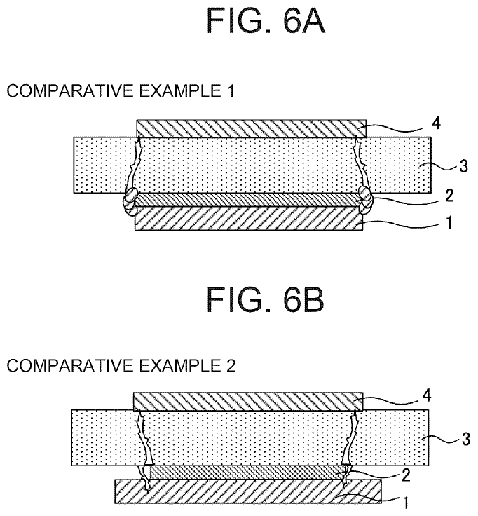

The solid-state battery shown in FIG. 6A was manufactured. This solid-state battery was manufactured by the same method as in Example 1, except that the areas of the respective layers were set to: solid electrolyte layer (diameter: 14.5 mm)>protection layer=negative electrode layer=positive electrode layer (all with a diameter of 11.28 mm). In the obtained solid-state battery, the solid electrolyte layer and the negative electrode layer came into contact with each other due to expansion and creeping of the negative electrode layer during charging, so that deposition and stretching of Li dendrites from a region where the protection layer was not disposed occurred, resulting in short-circuiting.

### Comparative Example 2

The solid-state battery shown in FIG. 6B was manufactured. This solid-state battery was manufactured by the same method as in Example 1, except that the areas of the respective layers were set to: solid electrolyte layer (diameter: 14.5 mm)>negative electrode layer>positive electrode layer (diameter: 11.28 mm)>protection layer. In the obtained solid-state battery, deposition and stretching of Li dendrites into the solid electrolyte layer from a region where the protection layer was not disposed occurred, resulting in short-circuiting.

### Example 2

A solid-state battery was manufactured by the same method as in Example 1, except that the areas of the respective layers were set to: solid electrolyte layer (diameter: 14.5 mm)>protection layer>positive electrode layer (diameter: 11.28 mm)>negative electrode layer. In the obtained solid-state battery, Li deposition occurred from the protection layer in a region where the negative electrode layer and the positive electrode layer did not face each other, resulting in degradation of the cycle characteristics and the rate characteristics. On the other hand, deposition and stretching of Li dendrites into the solid electrolyte layer did not occur, and thus short-circuiting was inhibited.

What is claimed is:

1. A solid-state battery that includes a negative electrode layer, a protection layer, a solid electrolyte layer, and a positive electrode layer in an order of the negative electrode layer, the protection layer, the solid electrolyte layer, and the positive electrode layer and uses a deposition-dissolution reaction of metal lithium, wherein:
the negative electrode layer includes a first metal element M1 that is able to alloy with lithium;
the protection layer includes a second metal element M2 that is able to alloy with lithium;
the first metal element M1 and the second metal element M2 are different elements; and
as seen in a sectional view of the solid-state battery along a thickness direction,
the protection layer has a first protruded portion that is protruded outward beyond an end face of the negative electrode layer in a direction orthogonal to the thickness direction, and
the solid electrolyte layer has a second protruded portion that is protruded outward beyond an end face of the protection layer in the direction orthogonal to the thickness direction.

2. The solid-state battery according to claim 1, wherein:
the solid-state battery comprises a negative electrode current collector on the opposite side of the negative electrode layer from the protection layer;
as seen in a sectional view along the thickness direction, the negative electrode current collector has an extended portion that is extended outward beyond the end face of the negative electrode layer in the direction orthogonal to the thickness direction; and
the extended portion has a bend in a region that overlaps the first protruded portion of the protection layer in the thickness direction.

3. The solid-state battery according to claim 2, wherein the extended portion of the negative electrode current collector and the first protruded portion of the protection layer are separated from each other.

4. The solid-state battery according to claim 2, wherein, as seen in a sectional view along the thickness direction, when a width of the first protruded portion of the protection layer on a side where the extended portion is present is α, a thickness of the negative electrode layer is β, and an angle of the bend of the extended portion on an acute angle side is θ, ═tanθ<β is met.

5. The solid-state battery according to claim 2, wherein, as seen in a sectional view along the thickness direction, a thickness of the first protruded portion of the protection layer on a side where the extended portion is present is smaller than a thickness of a region where the first protruded portion is not provided.
